(19) United States
(12) Patent Application Publication
(10) Pub. No.: US 2015/0363132 A1
(43) Pub. Date: Dec. 17, 2015

(54) INFORMATION PROCESSING APPARATUS, METHOD AND COMPUTER-READABLE STORAGE MEDIUM FOR SHUTTING DOWN INFORMATION PROCESSING APPARATUS

(71) Applicant: FUJITSU LIMITED, Kawasaki-shi (JP)

(72) Inventor: Mikio UEHARA, Kawasaki (JP)

(21) Appl. No.: 14/835,164

(22) Filed: Aug. 25, 2015

Related U.S. Application Data
(63) Continuation of application No. PCT/JP2013/057614, filed on Mar. 18, 2013.

(51) Int. Cl. G06F 3/06

(52) U.S. Cl. CPC G06F 3/0619; G06F 3/0653; G06F 3/0679

(57) ABSTRACT

An information processing apparatus includes a non-volatile storage device and a processor. The processor is configured to evacuate system information to the non-volatile storage device, when an outage is detected, after the evacuation, shut down the information processing apparatus, and when the information processing apparatus is restarted thereafter, resume a shutdown process on the information processing apparatus, using the system information in the non-volatile storage device.

### CROSS-REFERENCE TO RELATED APPLICATION

This application is a continuation application of International Application PCT/JP2013/057614 filed on Mar. 18, 2013 and designated the U.S., the entire contents of which are incorporated herein by reference.

### FIELD

The embodiments discussed herein are related to an information processing apparatus, a method of shutting down an information processing apparatus, and a non-transitory computer-readable storage medium having stored therein, a program for shutting down an information processing apparatus.

### BACKGROUND

In information processing systems, e.g., servers, uninterruptible power supply units (UPSs) having batteries therein, are used to protect the systems, when a supply of mains power from wall outlets is interrupted, such as when a power failure or outage occurs. As used herein, failure of electrical power is referred to as an “outage”. For example, in an information processing apparatus, a server is operated on electrical power supplied from a battery provided in a UPS upon an outage (upon a detection of the outage) for executing a shutdown process (apparatus shutdown process) on the server.

There are two types of UPSs: the constant inverter power supply type and the constant mains power supply type.

An inverter power supply type UPS converts mains power into direct current (DC) power using a rectifier, and generates alternating current (AC) power that is synchronized with the constant mains power, using a constant voltage flat frequency control inverter, while charging a battery. Since, in theory, no switch deviation arises upon a failure of the mains power, constant inverter power supply type UPSs are used for applications where no voltage drops or fluctuation of electrical power waveforms are allowed.

Constant inverter power supply type UPSs, however, suffer from significant losses caused by inverters that are constantly operated.

In contrast, a constant mains power supply type UPS converts mains power into direct current power using a rectifier while supplying the mains power to loads while the mains power is supplied normally. When the mains power is interrupted or the frequency fluctuates, a UPS in this type isolates the mains power and supplies power to the loads from an inverter. As compared to constant inverter power supply type UPSs, constant mains power supply type UPSs are advantageous in that since the inverter does not operate or there is no load while the mains power is supplied normally, the loss is reduced. On the other hand, they suffer from a relatively increased switch deviation upon a failure of the mains power.

In an information processing system, the time required to shut down a server upon an outage is divided into three durations: the time of recovery of power or time for waiting for recovery from the outage (Duration A); the time for shutting down applications (Duration B); and the time for shutting down the operating system (OS) (Duration C).

In a typical server, a shutdown process of applications and a shutdown process of the OS take several minutes. Thus, a UPS is needed to supply electrical power to a power input of a server during those several minutes. Some applications, such as database applications, take longer time, such as several minutes, for shutting down the applications, which increases the total shutdown time.

The feed time from an UPS upon an outage can be extended by providing a large-capacity battery to the UPS. The UPS itself consumes electrical power during a normal operation. Specifically, the circuit for converting AC power internal to the UPS to DC power for charging a battery consume electrical power, and the power consumption is increased as the capacity of the battery in the UPS increases.

With the recent increasing demand for power consumption, UPSs having high-capacity batteries, which consume high power, are not considered preferable. Hence, for avoiding any increase in battery capacities of UPSs, it is desired to speed up shutdown processes for information processing apparatuses, e.g., servers.

The present embodiment is conceived of in light of the above issues, and an object thereof is to shorten the time required for a shutdown process for an apparatus when an outage is detected.

In addition to the aforementioned object, obtaining advantageous effects, which are achieved by configurations described in the best mode for the practicing the embodiments described later and are not obtained from conventional techniques are also considered as objects of the present embodiments.

### SUMMARY

In one aspect, an information processing apparatus, including a non-volatile storage device and a processor, is provided. The processor is configured to evacuate system information to the non-volatile storage device, when an outage is detected, after the evacuation, shut down the information processing apparatus, and when the information processing apparatus is restarted thereafter, resume a shutdown process on the information processing apparatus, using the system information in the non-volatile storage device.

In another aspect, a method of shutting down an information processing apparatus, is provided. The method includes evacuating system information to a non-volatile storage device provided in the information processing apparatus, when an outage is detected, after the evacuation, shutting down the information processing apparatus, and when the information processing apparatus is restarted thereafter, resuming a shutdown process on the information processing apparatus, using the system information in the non-volatile storage device.

In a further aspect, a non-transitory computer-readable storage medium having stored therein, a program for shutting down an information processing apparatus, is provided. The program, when executed by a processor in the information processing apparatus, makes the processor to: evacuate system information to a non-volatile storage device provided in the information processing apparatus, when an outage is detected, after the evacuation, shut down the information processing apparatus, and when the information processing apparatus is restarted thereafter, resume a shutdown process on the information processing apparatus, using the system information in the non-volatile storage device.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram schematically illustrating a configuration of an information processing system as one example of an embodiment;

FIG. 2 is a diagram illustrating a detailed functional configuration of a server as one example of an embodiment;

FIG. 3 is a diagram illustrating a detailed configuration of the server as one example of an embodiment;

FIG. 4 is a diagram illustrating a memory configuration of the server as one example of an embodiment;

FIG. 5 is a flowchart illustrating processing in the information processing system as one example of an embodiment.

FIG. 6 is a diagram illustrating a shutdown process and an OS startup process during an execution of a quick application shutdown process in the information processing system as one example of an embodiment;

FIG. 7 is a flowchart illustrating processing for determining backup available duration as one example of an embodiment;

FIG. 8 is a diagram illustrating an example of shutdown processing time data;

FIG. 9 is a flowchart illustrating a quick application shutdown process by a shutdown speeding-up unit as one example of an embodiment; and

FIG. 10 is a flowchart illustrating a restart process of the server as one example of an embodiment.

### DESCRIPTION OF EMBODIMENTS

Hereinafter, embodiments of an information processing apparatus, a method of shutting down an information processing apparatus, and a non-transitory storage medium storing a program for shutting down an information processing apparatus will be described with reference to the drawings. Note that embodiments descried below are merely exemplary, and it is not intended that various modifications and variations that are not explicitly described, are not excluded. In other words, the present embodiments may be practiced by modifying in a various manner (such as combining any of embodiments and modifications thereto), without departing from the spirit thereof.

(A) Configuration

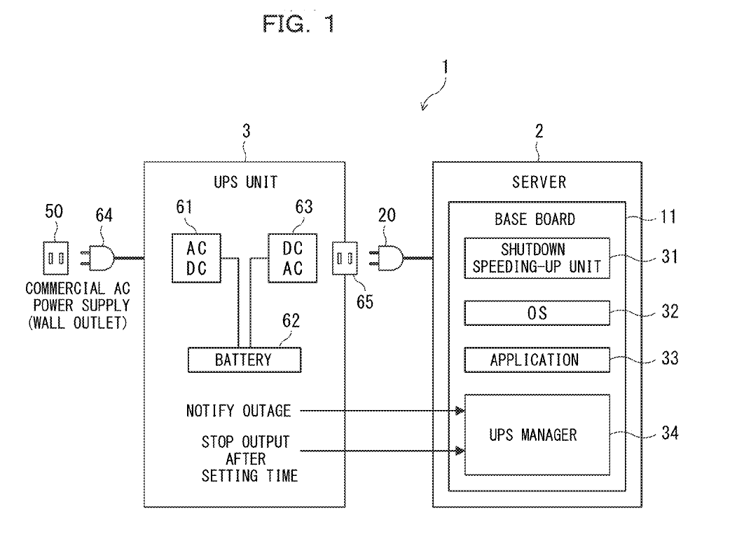

First, a configuration of an information processing system 1 as one example of an embodiment will be described with reference to FIGS. 1-4.

FIG. 1 is a diagram schematically illustrating a configuration of the information processing system 1 as one example of an embodiment.

The information processing system 1 includes a server (information processing apparatus) 2 and a UPS unit (uninterruptible power supply unit) 3.

The server 2 is a computer having a server function, for example, and carries out various types of data processing.

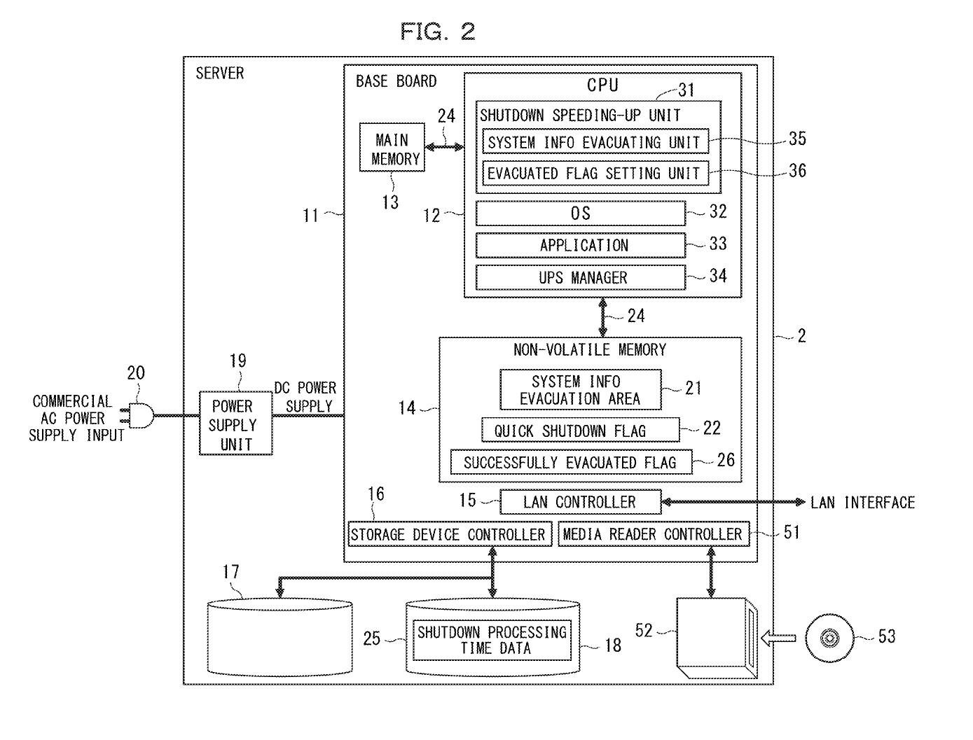

The server 2 includes a base board 11 and a power cable 20. The configuration of the server 2 will be described later with reference to FIGS. 2-4.

The UPS unit 3 is a constant inverter supply type or constant mains supply type power supply unit, which is supplied with mains AC power from a mains AC power supply 50, and outputs AC power. The server 2 is connected to the UPS unit 3, and can supply electrical power to the server 2 for a certain time duration (this time duration is also referred to as “feed time”), if an input power from the wall outlet 50 is disrupted. This backup available time may be set to any value by a user (e.g., system administrator), for example.

The UPS unit 3 includes an AC-DC converter 61, a battery 62, a DC-AC converter 63, a power cable 64, and an outlet 65.

The power cable 64 is connected to a mains AC power supply 50, e.g., a wall outlet, for example.

The AC-DC converter 61 converts alternating current power supplied from the mains AC power supply 50 through the power cable 64, to direct current, and supplies the direct current to the battery 62.

The battery 62 is a secondary battery that is charged with the direct current supplied from the AC-DC converter 61, and simultaneously supplies direct current to the DC-AC converter 63. The battery 62 can supply power to the DC-AC converter 63 using the power discharged from an internal secondary battery for a certain period of time, if the power supply from the AC-DC converter 61 is discontinued.

The DC-AC converter 63 converts the direct current supplied from the battery 62 to alternating current, and supplies the direct current outside the UPS unit 3 from the outlet 65.

The outlet 65 is an output for supplying the direct current outside the UPS unit 3, and is connected to the power cable 20 of the server 2 in the present example.

When the mains power fails and the power input from the wall outlet 50 is discontinued, the UPS unit 3 notifies the UPS manager 34 in the server 2 of the outage.

When a certain time duration (feed time) elapses after the commencement of the outage, the UPS unit 3 stops supplying the electrical power from the outlet 65.

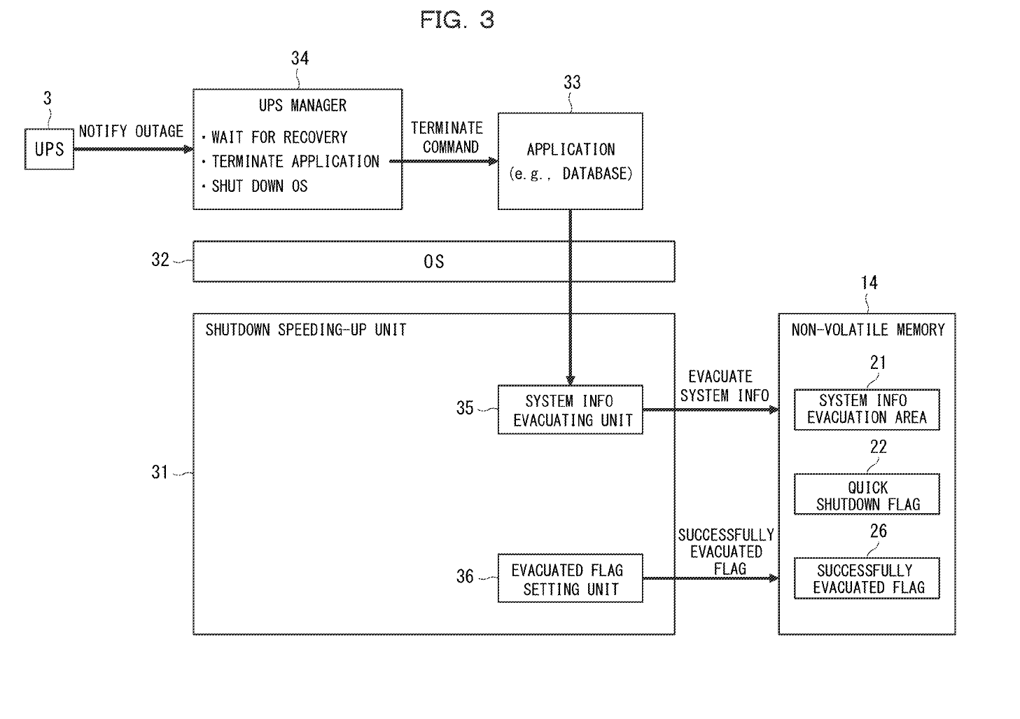

Next, the configuration of the server 2 will be described in more detail with reference to FIGS. 2-3.

FIG. 2 is a diagram illustrating a detailed functional configuration of the server 2 as one example of an embodiment, FIG. 3 is a diagram illustrating a detailed configuration of the server 2 as one example of an embodiment.

As depicted in FIG. 2, the server 2 includes the base board 11, storage devices 17 and 18, a power supply unit 19, the power cable 20, and a media reader 52.

The base board 11 is aboard on which major electrical circuits and electrical components included in the server 2 are provided. The base board 11 includes a central processing unit (CPU, processor) 12, a main memory (volatile storage device) 13, a non-volatile memory (non-volatile storage device) 14, a LAN controller 15, a storage device controller 16, and a media reader controller 51.

The CPU 12 is a processing unit that performs various types of controls and computations, and embodies various functions by executing a program stored in storage devices 17 and 18, or a read only memory (ROM; not illustrated), or the like. In the example in FIG. 2, the CPU 12 carries out an operating system (OS) 32 and at least one application 33. In addition, the CPU 12 functions as a shutdown speeding-up unit 31 and a UPS manager 34.

The OS 32 is system software that embodies basic functions of the server 2, such as hardware management. The OS 32 may be the UNIX® operating system, for example.

The application 33 is software that carries out predetermined processing, such as business processing, on the server 2. The application 33 is database application software, for example.

As will be described later, the shutdown speeding-up unit 31, when the UPS manager 34 determines that the backup available time of the battery 62 is not sufficiently long at a commencement of an outage, carries out a quick application shutdown process, thereby shortening the time for a shutdown process of the server 2.

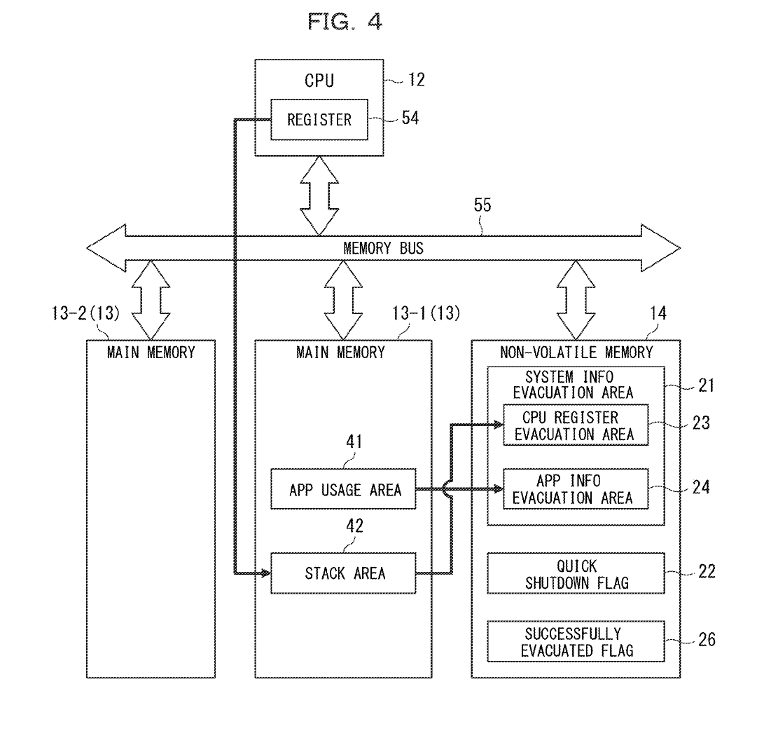

As used herein, “a quick application shutdown process” refers to processing in which information in a register 54 in the CPU 12 (refer to FIG. 4) and information on the application 33 being carried out on the server 2, are temporarily evacuated to a non-volatile memory 14 (described later), followed by terminating execution of the application 33. The action of executing the quick application shutdown process of the application 33 is referred to as “quick shutdown”. In the following description, the information in the register 54 in the CPU 12 (refer to FIG. 4) and the information on the application 33 being carried out are collectively referred to as “system information”. The shutdown process of the server 2 by shutting down the OS 32 after a quick application shutdown process of the application 33 is referred to as “fast shutdown processing”.

In contrast, processing by the OS 32 to shut down the application 33 in a manner such that the OS 32 can be shut down afterward is referred to as “a normal application shutdown process”. The action of executing a normal application shutdown process of the application 33 is referred to as “normal shutdown”. The shutdown process of the server 2 by shutting down the OS 32 after a normal shutdown of the application 33 is referred to as “normal shutdown processing”. In a normal application shutdown process, temporary evacuation of the system information to the non-volatile memory 14 is not carried out.

After a quick application shutdown process has been carried out, the shutdown speeding-up unit 31 shuts down the application 33 using data evacuated to the non-volatile memory 14 in the quick application shutdown process, after the power is restored (restoration of the power). Thereafter, the OS 32 is restarted and the application 33 is launched.

In contrast, after a normal application shutdown process has been carried out, the application 33 is launched after the power is restored and the OS 32 is launched.

Note that the shutdown speeding-up unit 31 operates on the same hierarchy as the hierarchy where a hypervisor in the server 2 resides. In other words, the shutdown speeding-up unit 31 operates on the hierarchy between the hardware of the server 2 and the OS 32.

The UPS manager 34 manages the UPS unit 3 that is connected to the server 2. The UPS manager 34 receives an outage notification indicating an occurrence of an outage, for example, from the UPS unit 3 at the commencement of the outage.

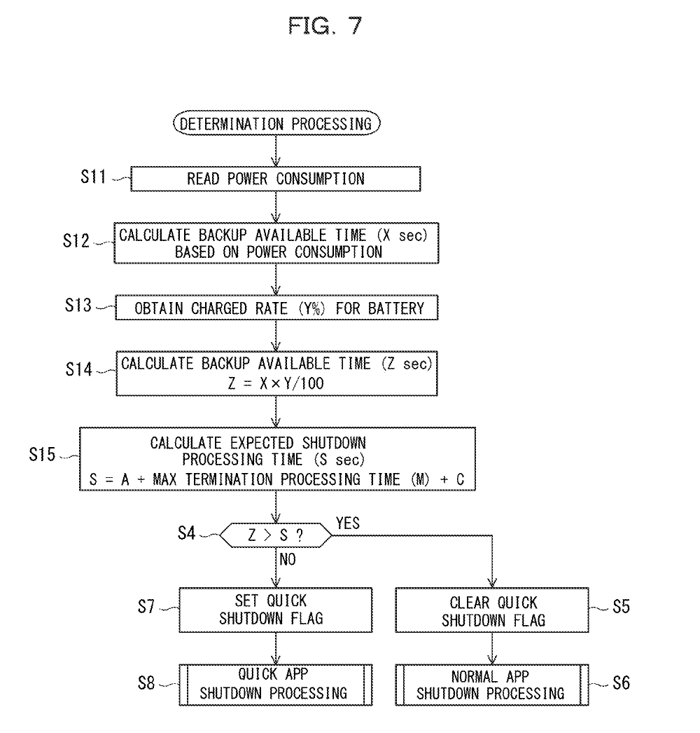

The UPS manager 34 calculates a duration (backup available time) during which the battery 62 in the UPS unit 3 can supply power for backup, from the capacity of the battery 62 in the UPS unit 3 and the power consumption of the server 2. The UPS manager 34 determines whether or not the backup available time is longer than expected processing time for a normal server shutdown process of the server 2 to carry out the quick application shutdown process of the application 33. This determination will be described later with reference to FIG. 7.

If the UPS manager 34 determines that the backup available time is sufficiently long to carry out a normal shutdown process of the server 2, the UPS manager 34 makes the OS 32 carry out a normal application shutdown process. Otherwise, if the UPS manager 34 determines that the backup available time is not sufficiently long, the UPS manager 34 instructs the shutdown speeding-up unit 31 to carry out a quick application shutdown process.

The main memory 13 is a volatile storage area that stores the application 33 that is being executed by the CPU 12 and various types of data obtained by operations of the CPU 12. The main memory 13 is a random access memory (RAM), for example.

The non-volatile memory 14 is embodied by a ferroelectric random access memory (FRAM®), which is a non-volatile storage area that can maintain data after the server 2 is powered down, for example. The non-volatile memory 14 stores system information, and includes a system information evacuation area 21, a quick shutdown flag 22, and a successfully evacuated flag 26.

The system information evacuation area 21 is an area to which a shutdown speeding-up unit 31 temporarily evacuates (saves) data of the application 33 upon an outage, as will be described later.

The quick shutdown flag 22 is a flag indicating whether or not quick shutdown has been carried out for the application 33 upon a last shutdown of the server 2. For example, if a quick application shutdown process was carried out upon the last shutdown of the server 2, the quick shutdown flag 22 assumes a value of “1”. Otherwise, if a normal application termination was carried out, the quick shutdown flag 22 assumes a value of “0”.

The successfully evacuated flag 26 is a flag indicating whether or not a shutdown was successfully performed by the shutdown speeding-up unit 31 upon an outage, as will be described later. For example, when a shutdown was successfully performed by the shutdown speeding-up unit 31 upon an outage, the successfully evacuated flag 26 assumes a value of “1”. Otherwise, if a shutdown was not successfully performed by the shutdown speeding-up unit 31 upon an outage, the successfully evacuated flag 26 assumes a value of “0”.

The LAN controller 15 controls a communication adaptor (e.g., a LAN interface) (not illustrated) in the server 2, for example, for connecting the server 2 to an external network, such as a LAN. The LAN controller 15 turns on the server 2 to communicate information with other servers and the like.

The storage device controller 16 controls the storage devices 17 and 18 (described later), such as hard disks.

The media reader controller 51 controls a media reader (described later).

The storage devices 17 and 18 are storage devices that store and save various programs, the OS 32, and data, and operate as disks for the server 2. The storage devices 17 and 18 also store shutdown processing time data 25 (described later). The storage devices 17 and 18 are hard disk drives (HDDs) or the like, for example.

Note that the storage device 17 also functions as a storage that stores the shutdown processing time data 25. The shutdown processing time data 25 stores the length of time that were spent for shutting down respective applications that were being executed on the server 2 when the server 2 underwent a last normal shutdown.

The media reader 52 is a drive that reads a storage medium 53, such as a CD-ROM or a DVD-ROM, and may be a CD-ROM drive or a DVD-ROM drive, for example.

Referring to FIG. 3, the shutdown speeding-up unit 31 includes a system information evacuating unit 35 that evacuates the system information in a system information evacuation area 21 in the non-volatile memory 14. The shutdown speeding-up unit 31 also includes an evacuated flag setting unit 36 that sets a successfully evacuated flag 26 in the non-volatile memory 14.

As depicted in FIG. 3, in response to receiving an outage notification from the UPS unit 3, the UPS manager 34 waits for a predetermined time duration and determines whether or not backup available time that represents the time duration in which the UPS unit 3 can supply power is sufficiently long to carry out a normal shutdown process of the server 2. If the UPS manager 34 determines that the server 2 can be normally shut down, the UPS manager 34 issues a termination command to the application 33 to make the application 33 carry out a normal application shutdown process. The UPS manager 34 also turns off the quick shutdown flag 22 in the non-volatile memory 14 (e.g., sets a value of “0”). Thereafter, the UPS manager 34 shuts down the OS 32.

Otherwise, if the UPS manager 34 determines that the backup available time is not sufficiently long, the UPS manager 34 instructs, via the OS 32, the shutdown speeding-up unit 31 to carry out a quick application shutdown process.

The shutdown speeding-up unit 31 carries out processing for evacuating the system information to the non-volatile memory 14. The shutdown speeding-up unit 31 also turns on the quick shutdown flag 22 in the non-volatile memory (e.g., sets a value of “1”).

If the temporary data is successfully evacuated, the shutdown speeding-up unit 31 turns on the successfully evacuated flag 26 (e.g., sets a value of “1”).

Thereafter, the UPS manager 34 shuts down the OS 32.

Next, referring to FIG. 4, an evacuation of data to the non-volatile memory 14 will be described.

FIG. 4 is a diagram illustrating a memory configuration of the server 2 as one example of an embodiment.

A typical information processing apparatus includes a CPU and a system memory, which are connected by a memory bus, and includes one or more memory modules, referred to as dual inline memory modules (DIMMs).

The server 2 of one example of the present embodiment includes DIMMs 13-1 and 13-2 as a main memory 13, and the non-volatile memory 14 for temporarily evacuating the system information, in place of a part of the DIMMs. The CPU 12, the DIMMs 13-1 and 13-2, and the non-volatile memory 14 are connected to each other through a memory bus 55.

As depicted in FIG. 4, in a quick application shutdown process, the system information evacuating unit 35 in the shutdown speeding-up unit 31 (refer to FIG. 3) saves contents in the register 54 in the CPU 12 and data in the stack area 42, to the stack area 42 in the DIMM 13-1 and the CPU register evacuation area 23 in the non-volatile memory 14, respectively. The contents in the register 54 in the CPU 12 include program counters, for example.

The system information evacuating unit 35 also evacuates an area 41 in the DIMM 13-1 used by the application 33 that is being executed, to the application information evacuation area 24 in the non-volatile memory 14. Note that the CPU register evacuation area 23 and the application information evacuation area 24 together represent the system information evacuation area 21 described above with reference to FIG. 3.

If the system information has been successfully stored into the non-volatile memory 14, the evacuated flag setting unit 36 in the shutdown speeding-up unit 31 sets a value of “1”, for example, to the successfully evacuated flag 26 in the non-volatile memory 14.

Note that in one example of the present embodiment, the CPU 12 in the server 2 is configured to function as the shutdown speeding-up unit 31, the system information evacuating unit 35, and the evacuated flag setting unit 36 by executing a non-transitory storage medium storing a program for shutting down an information processing apparatus.

The program (program for shutting down an information processing apparatus) for embodying the functions as the shutdown speeding-up unit 31, the system information evacuating unit 35, and the evacuated flag setting unit 36 is provided while being stored in a computer-readable storage medium 53, such as a flexible disk, a CD (e.g., a CD-ROM, CD-R, CD-RW), a DVD (e.g., DVD-ROM, DVD-RAM, DVD-R, DVD+R, DVD-RW, DVD+RW), a magnetic disk, an optical disk, a magneto-optical disk, and the like, for example. The server 2 reads the program from the storage medium 53 through the media reader 52 and transfers it into an internal storage device, before using it. The program may be stored on a storage device (storage medium), such as a magnetic disk, an optical disk, a magneto-optical disk, for example, and may be provided to the computer from that storage device through a communication path.

When embodying the functions as the shutdown speeding-up unit 31, the system information evacuating unit 35, and the evacuated flag setting unit 36, a program stored in an internal storage device (the main memory 13 in the server 2, in the present embodiment) is executed by a microprocessor in a computer (the CPU 12 in the server 2, in the present embodiment). The computer may read the program stored in a storage medium and execute the program.

Note that, in the present embodiment, the term “computer” may be a concept including hardware and an operating system, and may refer to hardware that operates under the control of the operating system. Alternatively, when an application program alone can make the hardware to be operated without requiring an operating system, the hardware itself may represent a computer. The hardware includes at least a microprocessor, e.g., CPU, and a means for reading a computer program recorded on a storage medium and, in the present embodiment, the server 2 includes a function as a computer.

(B) System Operation

Next, operations of the information processing system 1 in one example of the present embodiment will be described.

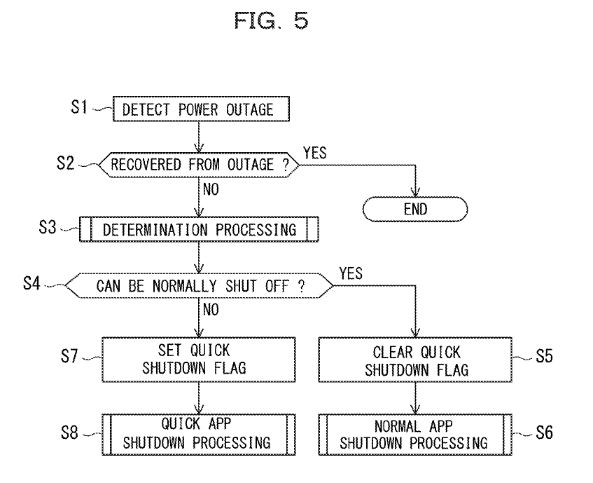

FIG. 5 is a flowchart (Steps S1-S8) illustrating processing in the information processing system 1 as one example of an embodiment.

In Step S1, the UPS unit 3 detects that power is discontinued, and notifies the UPS manager 34 in the server 2 of the occurrence of the outage.

Next, in Step S2, the UPS manager 34 determines whether or not the power is restored before a certain time duration (e.g., 60 seconds) elapses.

If the power is restored before the certain time duration elapses in Step S2 (refer to the YES route from Step S2), this flow is terminated. In this manner, the server 2 is prevented from being shut down in response to a short-term outage, known as an instant outage.

Otherwise, if the outage continues after the certain time duration elapses (refer to the NO route from Step S2), the UPS manager 34 carries out a shutdown process, which will be described later with reference to FIG. 7, in Step S3, to determine the capacity of the battery 62 and the power consumption of the server 2 and then determine whether or not the server 2 can be normally shut down.

If it is determined that the server 2 can be normally shut down in Step S3 (refer to the YES route from Step S4), the UPS manager 34 turns off the quick shutdown flag 22 (e.g., sets a value of “0”) in Step S5.

Next, in Step S6, the UPS manager 34 makes the application 33 carry out a normal application shutdown process.

Otherwise, if the backup available time is not sufficiently long in Step S3 (refer to the NO route from Step S4), in Step S7, the UPS manager 34 turns on the quick shutdown flag 22 (e.g., sets a value of “1”).

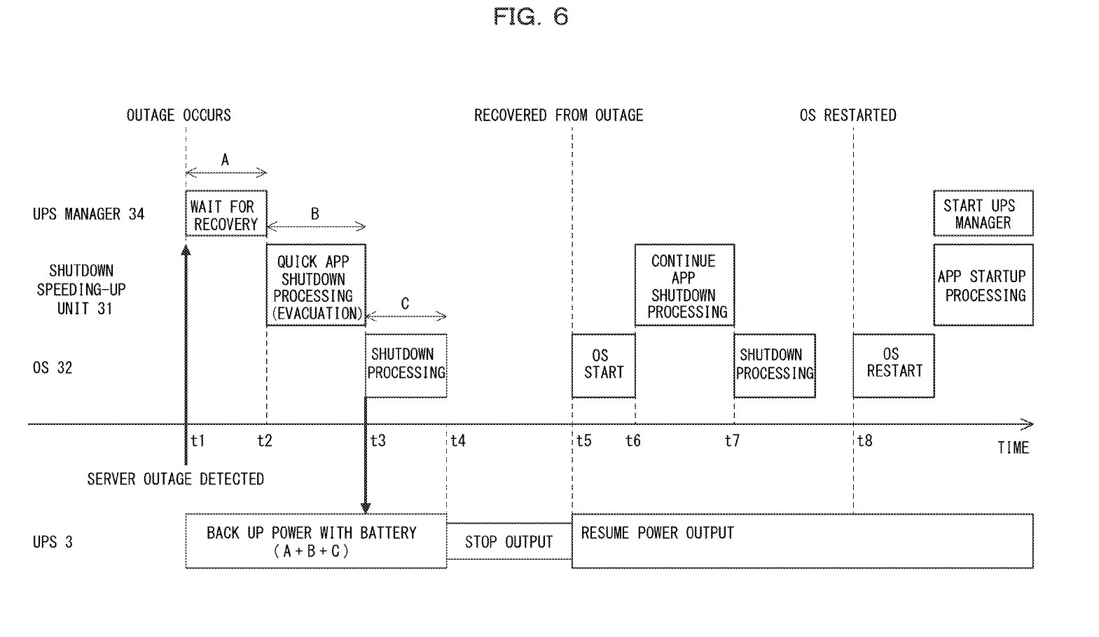

Next, in Step S8, the shutdown speeding-up unit 31 carries out a quick application shutdown process. The details of the processing in Step S8 will be described later with reference to FIG. 6.

Note that the quick application shutdown process is processing for temporarily evacuating the status of the application 33 that is being executed to the non-volatile memory 14, and is carried out in shorter time than the time that is taken for carrying out a normal application shutdown process.

Next, referring to FIG. 6, the quick application shutdown process will be described in detail.

FIG. 6 is a diagram illustrating a shutdown process and an OS startup process during an execution of a quick application shutdown process in the information processing system 1 as one example of an embodiment.

When an outage occurs at t1, as described above with reference to FIG. 5, the UPS manager 34 waits for the power to be restored for the predetermined set duration (Duration A).

After the certain time duration elapses, at t2, the UPS manager 34 determines whether or not the backup available time of the battery 62 is sufficiently long. Since the backup available time is not sufficiently long in the example in FIG. 6, the UPS manager 34 instructs the shutdown speeding-up unit 31 to carryout a quick application shutdown process. The time required for the quick application shutdown process is denoted as Duration B. The UPS manager 34 also instructs the UPS unit 3 to stop outputting power after a certain time duration (feed time) by sending a command.

Thereafter, at t3, the UPS manager 34 instructs the OS 32 to initiate a shutdown process. The time required for the shutdown process is denoted as Duration C.

When the shutdown of the OS 32 is completed and the feed time elapses at t4, the UPS unit 3 stops outputting electrical power.

In the example in FIG. 6, the total time duration required for shutting down the information processing system 1 (Duration A+Duration B+Duration C) is shorter than the time required for executing the normal application shutdown process in Step S6 in FIG. 5.

Thereafter, at t5, electrical power is restored, and the OS 32 in the server 2 is launched.

After the OS 32 is launched, at t6, the OS 32 checks the quick shutdown flag 22 to determine whether or not a quick application shutdown process has been carried out during the last execution of the OS 32. If a quick application shutdown process has been carried out during the last execution of the OS 32 checks the successfully evacuated flag 26 to determine whether or not system data has been stored in the non-volatile memory 14.

If the successfully evacuated flag 26 is set to ON, the OS 32 reads the system information from the non-volatile memory 14 and restores it into the register 54 in the CPU 12 and the main memory 13, and continues the execution of the normal application shutdown process, based on the restored system information.

After the normal application shutdown process is completed, the OS 32 carries out a shutdown process at t7 and restarts the OS 32 at t8. Thereafter, the UPS manager 34 and the application 33 that was being executed on the server 2 before the outage, are launched.

As described above, in the information processing system 2, since the backup available time of the battery 62 in the UPS unit 3 is not sufficiently long upon an outage, after a quick application shutdown process is carried out and then the application shutdown process is resumed after the power is restored.

FIG. 7 illustrates a flow (Steps S11-S15 and S4-S8) for the processing for determining the backup available time in Step S3 in FIG. 5. In FIG. 7, Steps S4-S8 are the same as Steps S4-S8 described above in FIG. 5.

In Step S11, the UPS manager 34 obtains, from the server 2, the power consumption of the server 2. Note that the power consumption is obtained from a baseboard management controller (BMC) (not illustrated) in the server 2, for example.

In Step S12, the UPS manager 34 calculates backup available time X (seconds) based on the power consumption obtained in Step S11.

Next, in Step S13, the UPS manager 34 obtains, from the UPS unit 3, a charge ratio Y % (Y=0-100) of the battery 62 in the UPS unit 3. For obtaining the information, the UPS manager 34 issues a command to the UPS unit 3, for example.

In Step S14, the UPS manager 34 calculates backup available time Z (seconds) from the charge ratio of the battery 62 obtained in Step S13, based on the power consumption. The UPS manager 34 calculates the backup available time Z, using the formula: Z=X×Y/100, for example.

Next, in Step S15, the UPS manager 34 calculates expected time S (seconds) required for carrying out a shutdown process of the server 2. For this calculation, the UPS manager 34 looks up shutdown processing time data 25 that has been stored in the storage device 18 in the server 2, and calculates the processing time of an application that has taken the longest time in a shutdown process during the last shutdown of the server 2, as the maximum shutdown time M (seconds).

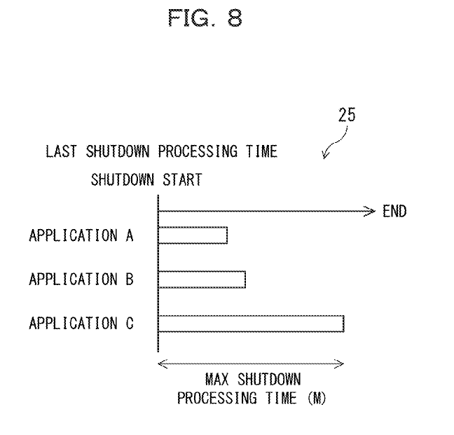

FIG. 8 is a diagram illustrating an example of the shutdown processing time data 25.

The actual shutdown processing time data 25 is stored in a table format, such as a table in a database, for example, for the sake of illustration, however, the shutdown processing time data 25 is depicted in a graphical format in FIG. 8. In the example in FIG. 8, Application C required the longest shutdown time during the last shutdown of the server 2. In this case, the UPS manager 34 obtains the last shutdown time for Application C, as the maximum shutdown time M (seconds).

The UPS manager 34 then calculates expected shutdown process time S, using the formula: Wait Duration A (refer to FIG. 6)+maximum shutdown process time+Shutdown Duration C (refer to FIG. 6).

Thereafter, as described above, in Step S4 (refer to FIGS. 5 and 7), the UPS manager 34 compares the value Z calculated in Step S14 in FIG. 7, with the value S calculated in Step S15 in FIG. 7, and determines that the shutdown time is sufficiently long when Z>S. If the shutdown time is determined as sufficient (refer to the YES route from Step S4), a normal application shutdown process is carried out in Step S6. If the shutdown time is determined as insufficient (refer to the NO route from Step S4), a quick application shutdown process is carried out in Step S8. In either case, a predetermined value is set to the quick shutdown flag 22 in Steps S5 and S7.

Next, a quick application shutdown process by the shutdown speeding-up unit 31 will be described.

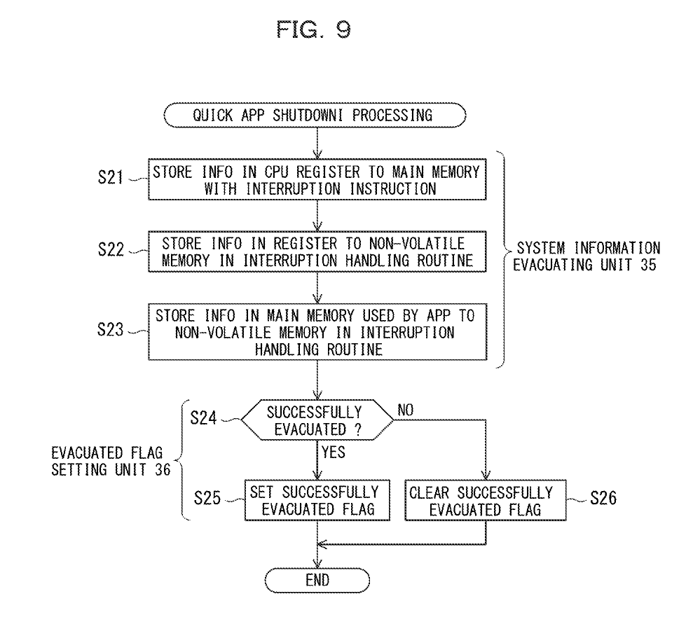

FIG. 9 is a flowchart illustrating a quick application shutdown process by the shutdown speeding-up unit 31 as one example of an embodiment.

In Step S21, the system information evacuating unit 35 in the shutdown speeding-up unit 31 issues a software interruption instruction for storing contents in the register 54 in the CPU 12 at the time of the issuance of the instruction, to the stack area 42 in the main memory 13, as depicted in FIG. 4.

Next, in Step S22, the system information evacuating unit 35 in the shutdown speeding-up unit 31 stores contents in the stack area 42 in the main memory 13, to the CPU register evacuation area 23 in the non-volatile memory 14, in an interruption handling routine.

Next, in Step S23, the system information evacuating unit 35 in the shutdown speeding-up unit 31 stores information in the main memory 13 used by the application 33 that is being executed, to the application information evacuation area 24 in the non-volatile memory 14, in the interruption handling routine.

Next, in Step S24, the evacuated flag setting unit 36 in the shutdown speeding-up unit 31 determines whether or not the system information was successfully evacuated in Steps S22 and S23.

If the system information was successfully evacuated (refer to the YES route from Step S24), in Step S25, the evacuated flag setting unit 36 in the shutdown speeding-up unit 31 turns on the successfully evacuated flag 26 in the non-volatile memory (e.g., sets a value of “1”).

Otherwise, if the evacuation of the system information failed (refer to the NO route from Step S24), in Step S26, the evacuated flag setting unit 36 in the shutdown speeding-up unit 31 turns off the successfully evacuated flag 26 in the non-volatile memory 14 (e.g., sets a value of “0”).

Next, processing upon a restart of the server 2 will be described.

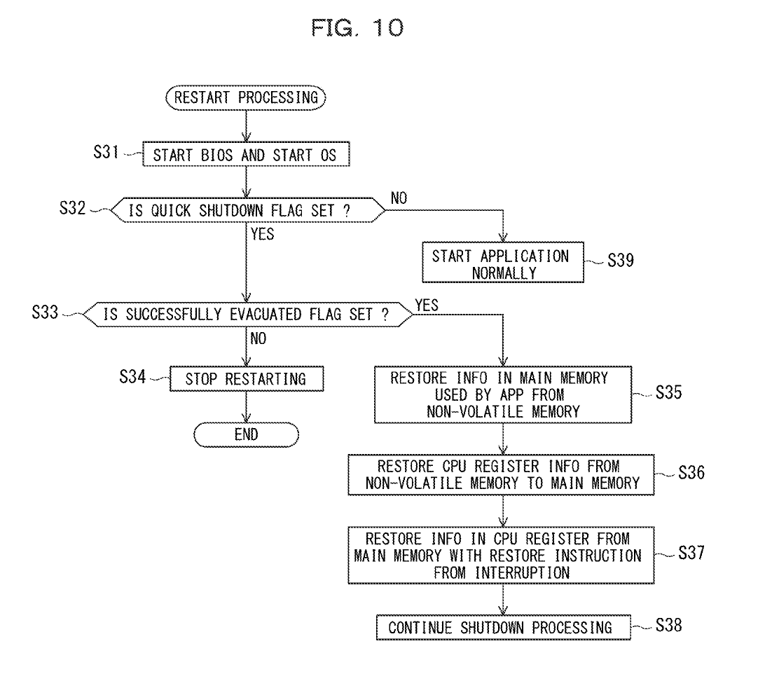

FIG. 10 is a flowchart illustrating a restart process of the server 2 as one example of an embodiment.

When the electrical power is restored (restoration of the power), the UPS unit 3 notifies the server 2 of the restoration of the power and a BIOS (not illustrated) of the server 2 is launched and the OS 32 is launched in Step S31.

Next, in Step S32, the OS 32 in the server 2 determines whether or not the quick shutdown flag 22 in the non-volatile memory 14 is set to ON.

When the quick shutdown flag is set to ON (refer to the YES route from Step S32), in Step S33, the shutdown speeding-up unit 31 determines whether or not the successfully evacuated flag 26 in the non-volatile memory 14 is set to ON.

If the successfully evacuated flag 26 in the non-volatile memory 14 is set to OFF (refer to the NO route from Step S33), the last quick application shutdown process failed. Thus, in Step S34, the shutdown speeding-up unit 31 aborts the restart process of the server 2. In this case, a user (e.g., system administrator) may be notified of an error, for example.

Otherwise, if the successfully evacuated flag 26 is set to ON (refer to the YES route from Step S33), in Step S35, the shutdown speeding-up unit 31 restores the application information from the application information evacuation area 24 to the application usage area 41.

In Step S36, the shutdown speeding-up unit 31 restores the information in the register 54 in the CPU 32 from the CPU register evacuation area 23 in the non-volatile memory 14 to the stack area 42 in the main memory 13.

In Step S37, the shutdown speeding-up unit 31 restores the CPU register information from the stack area 42 in the main memory 13 to the register 54 in the CPU 32.

In Step S38, the shutdown speeding-up unit 31 instructs the application 33 to carry out a normal shutdown process, and shuts down the application 33.

Otherwise, if the quick shutdown flag 22 in the non-volatile memory 14 is set to OFF in Step S32 (refer to the NO route from Step S32), a normal application shutdown process was carried out upon the last shutdown and hence the application is launched in a standard manner.

Thereafter, a shutdown process is carried out on the application 33 to shut down the application 33.

(C) Advantageous Effects

As described above, the server 2 as one example of an embodiment includes the shutdown speeding-up unit 31 in the hierarchy that is equivalent to the hierarchy of the hypervisor, and includes the non-volatile memory 14 as a part of the system memory.

When an outage occurs, the shutdown speeding-up unit 31 looks up the information that was gathered during the last shutdown and calculates expected backup available time. If the capacity of the battery 62 is expected to be insufficient, the shutdown speeding-up unit 31 shortens the shutdown time of the application 33 and shuts down the server 2 immediately. When the server 2 is restarted, the shutdown speeding-up unit 31 resumes the shutdown process of the application 33 and shuts down and then restarts the OS 32. In this manner, the server 2 as one example of an embodiment can shorten the time required for a shutdown process of the server 2 upon an outage.

Since the shutdown process time of the application 33 on the server 2 is reduced upon the outage, the shutdown time of the server 2 is also reduced. Thus, measures against power failures can be taken using a UPS unit 3 including a smaller-capacity battery 62 than a battery in a conventional USP.

As a result, electrical power for charging the battery 62 in the UPS unit 3 is saved, which also helps to reduce the total power consumption for the information processing system 1.

(D) Miscellaneous

The aforementioned techniques are not limited to the embodiments described above and various modifications can be made without departing from the spirit of the present embodiment.

For example, while a FRAM is used as the non-volatile memory 14 in the above-described embodiment, non-volatile memories in any other types may also be used.

Further, while the system memory includes a volatile main memory 13 and a non-volatile memory 14 in the above-described embodiment, the system memory may only include non-volatile memories.

Furthermore, while the UPS unit 3 is a constant inverter supply type UPS in the above-described embodiment, UPS units 3 in any other types may also be used, such as a constant mains power supply type UPS.

Furthermore, while the quick shutdown flag 22 and the successfully evacuated flag 26 are provided as separate flags in the above-described embodiment, those flags may be embodied as a single having a two- or more bit value.

In accordance with the disclosed embodiments, the time required for a shutdown process for an apparatus can be reduced when an outage is detected.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. An information processing apparatus, comprising:
a non-volatile storage device; and
a processor, the processor is configured to:
evacuate system information to the non-volatile storage device, when an outage is detected,
after the evacuation, shut down the information processing apparatus, and
when the information processing apparatus is restarted thereafter, resume a shutdown process on the information processing apparatus, using the system information in the non-volatile storage device.

2. The information processing apparatus according to claim 1, wherein the processor is further configured to:
when the outage is detected, determine whether or not supply time is sufficiently long to execute the shutdown process on the information processing apparatus, the supply time being a time duration during which an uninterruptible power supply unit can supply electrical power, and
when it is determined that the supply duration is not sufficient to execute the shutdown process on the information processing apparatus, evacuate the system information to the non-volatile storage device.

3. The information processing apparatus according to claim 1, wherein the system information comprises information in a register in the processor in the information processing apparatus, and information on an application being executed of the information processing apparatus.

4. The information processing apparatus according to claim 3, wherein the processor is configured to make the determination based on time that has been taken for a shutdown process of the application during a last shutdown process of the information processing apparatus.

5. The information processing apparatus according to claim 3, further comprising a volatile storage device,
wherein the processor is configured to evacuate the content in the register in the processor to the volatile storage device, and then evacuate the content to the non-volatile storage device.

6. A method of shutting down an information processing apparatus, the method comprising:
evacuating system information to a non-volatile storage device provided in the information processing apparatus, when an outage is detected,
after the evacuation, shutting down the information processing apparatus, and
when the information processing apparatus is restarted thereafter, resuming a shutdown process on the information processing apparatus, using the system information in the non-volatile storage device.

7. The method according to claim 6, further comprising:
when the outage is detected, determining whether or not supply time is sufficiently long to execute the shutdown process on the information processing apparatus, the supply time being a time duration during which an uninterruptible power supply unit can supply electrical power, and
when it is determined that the supply duration is not sufficient to execute the shutdown process on the information processing apparatus, evacuating the system information to the non-volatile storage device.

8. The method according to claim 6, wherein the system information comprises information in a register in the processor in the information processing apparatus, and information on an application being executed of the information processing apparatus.

9. The method according to claim 8, further comprising making the determination based on time that has been taken for a shutdown process of the application during a last shutdown process of the information processing apparatus.

10. The method according to claim 8, further comprising evacuating the content in the register in the processor to a volatile storage device provided in the information processing apparatus, and then evacuating the content to the non-volatile storage device.

11. A non-transitory computer-readable storage medium having stored therein, a program for shutting down an information processing apparatus, the program, when executed by a processor in the information processing apparatus, making the processor to:
evacuate system information to a non-volatile storage device provided in the information processing apparatus, when an outage is detected,
after the evacuation, shut down the information processing apparatus, and
when the information processing apparatus is restarted thereafter, resume a shutdown process on the information processing apparatus, using the system information in the non-volatile storage device.

12. The non-transitory computer-readable storage medium according to claim 11, wherein the program further makes the processor to:
when the outage is detected, determine whether or not supply time is sufficiently long to execute the shutdown process on the information processing apparatus, the supply time being a time duration during which an uninterruptible power supply unit can supply electrical power, and
when it is determined that the supply duration is not sufficient to execute the shutdown process on the information processing apparatus, evacuate the system information to the non-volatile storage device.

13. The non-transitory computer-readable storage medium according to claim 11, wherein the system information comprises information in a register in the processor in the information processing apparatus, and information on an application being executed of the information processing apparatus.

14. The non-transitory computer-readable storage medium according to claim 13, wherein the program further makes the processor to make the determination based on time that has been taken for a shutdown process of the application during a last shutdown process of the information processing apparatus.

15. The non-transitory computer-readable storage medium according to claim 13, wherein the program further makes the processor to evacuate the content in the register in the processor to a volatile storage device provided in the information processing apparatus, and then evacuating the content to the non-volatile storage device.
